(19) United States
(12) Patent Application Publication
(10) Pub. No.: US 2026/0219746 A1
(43) Pub. Date: Jul. 30, 2026

(54) SMART GLASSES WITH VIRTUAL BUTTON AND OPERATING MEHOD THEREOF

(71) Applicant: SOLOS TECHNOLOGY (SHENZHEN) LIMITED, Shenzhen (CN)

(72) Inventors: Chiu Ming So, Shenzhen (CN); Wai Kuen Kenny Cheung, Shenzhen (CN); Kwok Wah Law, Shenzhen (CN); Chi Sum Yu, Shenzhen (CN)

(21) Appl. No.: 19/572,915

(22) Filed: Mar. 20, 2026

Related U.S. Application Data
(63) Continuation of application No. PCT/CN2024/114386, filed on Aug. 24, 2024.

(30) Foreign Application Priority Data
Sep. 20, 2023 (CN) 202311221886.8

(51) Int. Cl. G06F 3/0354; G06F 3/16

(52) U.S. Cl. CPC G06F 3/03547; G06F 3/167

(57) ABSTRACT

Disclosed are smart glasses without a physical button and an operating method thereof. The smart glasses include a frame; a first temple; a second temple; and a controller embedded in the frame or in one of the temples. The first and second temples are connected to the frame. A first touch sensor is built in the first temple and connected to the controller, and the first touch sensor is configured to send a sensed touch operation signal to the controller. The controller is configured to control the smart glasses to be turned on or be turned off based on the touch operation signal. Without physical buttons, it effectively improves the waterproof performance of the smart glasses and makes the smart glasses easier to clean. In addition, since it is unnecessary to specially design molds for and manufacture physical buttons, the production cost of the smart glasses is also reduced.

### CROSS-REFERENCE TO RELATED APPLICATIONS

The present disclosure is a Continuation Application of PCT Application No. PCT/CN2024/114386, filed on August 24, 2024, which claims priority to Chinese Patent Application No. 202311221886.8, filed on September 20, 2023, the entire contents of which are hereby incorporated by reference.

### TECHNICAL FIELD

The present disclosure relates to the technical fields of smart wearable products, and in particular to smart glasses without a physical button and an operating method thereof.

### BACKGROUND

Smart glasses are increasingly applied in various aspects in life, such as work, and entertainment. Most smart glasses require at least one physical button serving as a switch for starting up or shutting down. The advantage of physical buttons is that users can easily perceive the operation process and the state of the button when performing the turn-on and turn-off operations.

However, physical buttons also have certain disadvantages. For example, it is difficult for devices with physical buttons to achieve IP67-level waterproof performance. In practice, users who wear glasses often have the habit of cleaning their glasses with water. Therefore, the presence of physical buttons makes the cleaning of the glasses inconvenient. In addition, as an independent component, a physical button requires dedicated mold development and manufacturing processes, thereby increasing production costs.

### SUMMARY

The present disclosure aims to improve the waterproof performance of smart glasses, make the smart glasses easier to clean, and reduce the manufacturing cost of the smart glasses.

In one aspect of the present disclosure, the present disclosure provides smart glasses without a physical button, including: a frame; a first temple; a second temple; and a controller. The controller is embedded in the frame, the first temple or the second temple. The first and second temples are connected to the frame.

A first touch sensor is built in the temple and connected to the controller, and the first touch sensor is configured to send a sensed touch operation signal to the controller.

The controller is configured to control the smart glasses to be turned on or turned off based on the touch operation signal.

In another aspect of the present disclosure, the present disclosure further provides an operating method of smart glasses without a physical button. The smart glasses include: a frame; a first temple; a second temple; and a controller. The controller is embedded in the frame, the first temple or the second temple. The first and second temples are connected to the frame, and a first touch sensor is built in the temple and connected to the controller. The operating method includes:

sensing, by the first touch sensor, a touch operation of a user to generate a touch operation signal; and

controlling, by the controller, the smart glasses to be turned on or be turned off in response to the touch operation signal.

In the embodiments of the present disclosure, the smart glasses do not include any physical button. Instead, a touch sensor built in a temple of the glasses is used to detect touch operations of a user, thereby implementing functions such as starting up or shutting down the smart glasses and performing other intelligent control operations. By eliminating physical buttons, the temple of the smart glasses can form a monolithic and homogeneous surface structure, and there is no need to worry about moisture or water entering the interior of a button through gaps around the edges of a physical button. As a result, the waterproof performance of the smart glasses is effectively improved, the smart glasses become easier to clean, and the manufacturing cost is reduced because no dedicated molds or manufacturing processes are required for physical buttons.

### BRIEF DESCRIPTION OF DRAWINGS

In order to more clearly illustrate the technical solutions in the embodiments of the present disclosure, the accompanying drawings required for describing the embodiments or the prior art will be briefly introduced below. It is apparent that the accompanying drawings described below merely illustrate some embodiments of the present disclosure.

FIG. 1A and 1B are two schematic views of smart glasses without a physical button according to a first embodiment of the present disclosure;

FIG. 2 is a schematic view of a temple according to the first embodiment of the present disclosure;

FIG. 3 is a schematic view of a first touch sensor and a second touch sensor in the temple according to the first embodiment of the present disclosure;

FIG. 4 is a schematic view of modules of the smart glasses without the physical button according to the first embodiment of the present disclosure;

FIG. 5 is another schematic view of modules of the smart glasses without the physical button according to the first embodiment of the present disclosure;

FIG. 6 is a schematic view illustrating switching among working modes of the smart glasses without the physical button according to the first embodiment of the present disclosure;

FIG. 7 is a flow chart of an operating method of smart glasses without a physical button according to a second embodiment of the present disclosure;

FIG. 8 is a flow chart of the operating method of the smart glasses without the physical button according to the second embodiment of the present disclosure, when in a turn-on state;

FIG. 9 is a flow chart of the operating method of the smart glasses without the physical button according to the second embodiment of the present disclosure, when in a turn-off state;

FIG. 10 is a flow chart of the operating method of the smart glasses without the physical button according to the second embodiment of the present disclosure, when in a music playback mode, a voice assistant running mode, or a call mode;

FIG. 11 is a flow chart of the operating method of the smart glasses without the physical button according to the second embodiment of the present disclosure, when in the call mode and in case that there is a new call; and

FIG. 12 is a flow chart of the operating method of the smart glasses without the physical button according to the second embodiment of the present disclosure, when in a call control mode.

### DESCRIPTION OF EMBODIMENTS

In order to make the objectives, technical solutions, and advantages of the embodiments of the present disclosure clearer, the technical solutions in the embodiments of the present disclosure will be described clearly and completely below with reference to the accompanying drawings in the embodiments of the present disclosure. It should be understood that the described embodiments are only some embodiments of the present disclosure, rather than all embodiments. Based on the embodiments disclosed in the present disclosure, all other embodiments obtained by a person skilled in the art without making any inventive effort shall fall within the scope of protection of the present disclosure.

In the following description, the terms "include", "comprise", "have", and their derivatives that may be used in various embodiments of the present disclosure are intended to indicate the presence of stated features, numbers, steps, operations, elements, components, or combinations thereof, but do not exclude the presence or addition of one or more other features, numbers, steps, operations, elements, components, or combinations thereof.

In addition, the terms "first", "second", "third", and the like are used merely for the purpose for distinguishing description, and should not be interpreted as indicating or implying relative importance. Furthermore, the features indicated by "first", "second", and the like may be the same or different. For example, the "first prompt sound" and the "second prompt sound" mentioned below are only used to indicate prompt sounds in different processes or procedures, and may be the same prompting mode, such as both being a single "beep" sound, or may be different prompting modes, such as one being a single "beep" sound and the other being a continuous "beep" sound. Similarly, "light of a first color" and "light of a second color" may be the same color or different colors.

Unless otherwise defined, all terms (including technical and scientific terms) used herein have the same meaning as commonly understood by a person skilled in the art to which the embodiments of the present disclosure belong. Such terms (for example, those defined in commonly used dictionaries) should be interpreted as having meanings consistent with their meanings in the context of the relevant technical field and should not be interpreted in an idealized or overly formal sense unless explicitly defined in the embodiments of the present disclosure.

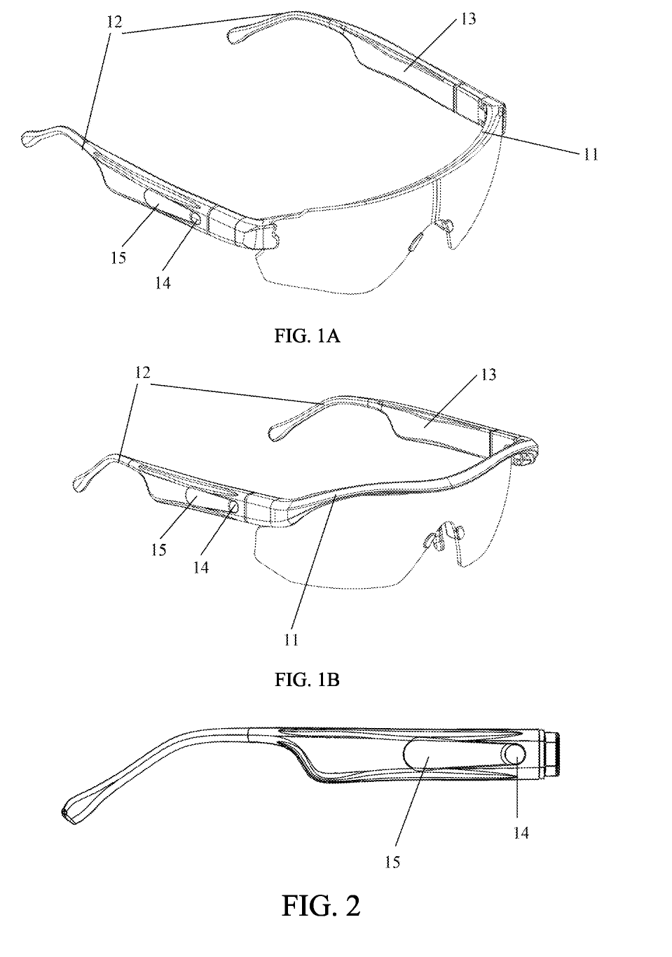

Referring to FIGS. 1A, 1B, 2,3, and 4, an external schematic view and an internal module diagram of smart glasses without a physical button according to a first embodiment of the present disclosure are illustrated. The smart glasses include a frame 11, two temples 12 connected to the frame 11, and a controller 10 built in one of the frame 11 and the temples 12.

Lenses are mounted on the frame 11. The lenses may be ordinary lenses, sunglass lenses, or functional lenses for vision correction, anti-reflective protective lenses, colored lenses, tinted lenses, polarized lenses, photochromic lenses, and the like. The lenses may adopt a curved shape as shown in FIGS. 1A and 1B, or other shapes. When curved lenses are adopted, the two lenses may form a monolithic and homogeneous structure.

Since curved lenses have no gap between the positions corresponding to the two eyes, and both sides of the curved lenses bend inward relative to the middle position, the curved lenses can better fit and cover the side regions of the eyes, thereby providing comprehensive shielding for the eyes and preventing ultraviolet rays in sunlight from entering the eyes.

The difference between FIG. 1A and FIG. 1B lies in that the curvatures of the lenses are different, and they are suitable for different face shapes. The curved lenses are mounted on an outer surface of the frame 11 through a snap-fit structure, which also facilitates replacement of different types of lenses.

In an embodiment, the frame 11 and the two temples 12 may be detachably connected, so that a user can replace frames and temples of different styles and colors for matching purposes. For example, a blue-light blocking frame may be used during work, while a sunglass frame may be used during sports or outdoor activities. Alternatively, the frame 11 and the temples 12 may also adopt a non-detachable connection, and the design may be flexibly selected without limitation.

The smart glasses include two temples 12, as shown in FIGS. 1A and 1B. A battery 13 is built in one of the two temples. The battery 13 is configured to supply power to various electronic functional modules of the smart glasses. These electronic functional modules may be built in the frame 11 and/or the temples 12. In an embodiment, the battery 13 may be built in a first temple, while the electronic functional modules may be built in a second temple. The battery 13 is connected to the electronic functional modules through electrical lines, and cables may be embedded or arranged within the frame 11.

A first touch sensor 14 is built in one of the two temple 12. The first touch sensor 14 is connected to the controller 10 and is configured to send a sensed touch operation signal to the controller 10. The controller 10 is configured to control the turn-on or turn-off states of the smart glasses based on the touch operation signal.

In the present disclosure, the turn-on station means that the electronic functional modules of the smart glasses are in a normal working state. The turn-off state means that only the first touch sensor 14 is powered and remains in a normal working state, while the other electronic functional modules are not powered and therefore cannot operate. In the turn-off state, the overall power consumption of the smart glasses is very low.

In an embodiment, as shown in FIG. 2, a surface of the temple 12 includes a first surface region corresponding to the first touch sensor 14 and a remaining region, and the first surface region is non-coplanar with the remaining region of the temple 12. In this way, users can easily locate the position of the first touch sensor 14 during operation.

Specifically, the configuration in which the first surface region is non-coplanar with the remaining region of the temple 12 may be implemented in two ways.

In a first implementation, the first surface region protrudes from the remaining region of the temple 12. In this case, a second surface region may further be defined surrounding the first surface region within a preset range, and the second surface region is designed to be recessed relative to other surface regions of the temple 12. By designing the region surrounding the first surface region as recessed, the first surface region becomes more prominent relative to its surroundings, thereby enhancing the three-dimensional effect and enabling the user to more easily locate the first touch sensor 14 during touch operations.

In a second implementation, the first surface region is recessed relative to the remaining region of the temple 12. In this case, a second surface region surrounding the first surface region within a preset range may be designed to protrude from other surface regions of the temple 12. As a result, the first surface region becomes more recessed relative to its surroundings, enhancing the three-dimensional tactile perception and making it easier for the user to quickly locate the first touch sensor 14 during touch operations.

Further, the temple 12 may further include a second touch sensor 15, which is connected to the controller 10 and configured to send a sensed sliding operation signal to the controller 10. The controller 10 is configured to control the working state of the smart glasses based on the sliding operation signal.

The second touch sensor 15 is mainly used, after the smart glasses be turned on, to allow a user to control the smart glasses through a sliding operation. The first touch sensor 14 described above is mainly used for a user to be turned on or be turned off the smart glasses through a tapping operation, or to control the working state of the smart glasses after the smart glasses starts up.

The second touch sensor 15 and the first touch sensor 14 may be disposed on different temples, or may be disposed on the same temple. When they are disposed on the same temple, the surface of the temple 12 corresponding to the second touch sensor 15 is defined as a third surface region. A first isolation region G1, which has no touch detection function, is provided between the third surface region and the first surface region corresponding to the first touch sensor 14.

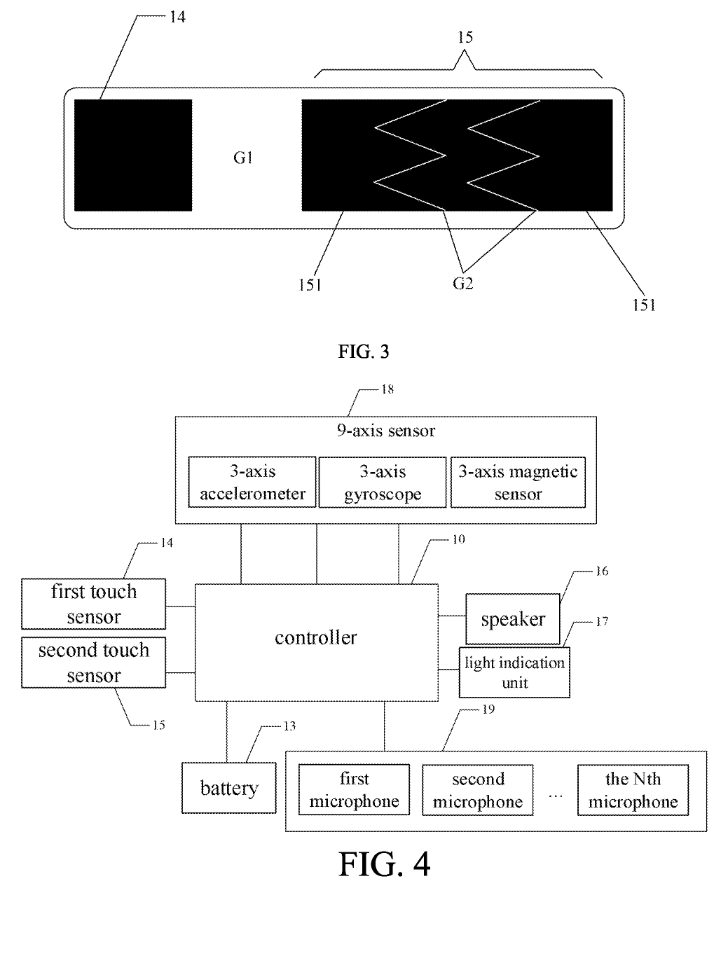

Further, as shown in FIG. 3, the second touch sensor 15 includes a plurality of touch sensor units 151. A second isolation region G2, which has no touch detection function, is provided between every two adjacent touch sensor units 151. The second isolation region G2 may be designed in a zigzag shape. The design of the plurality of separated touch sensor units 151 enables more sensitive detection of a sliding direction of a user.

In addition, in the structure shown in FIG. 3, a second surface region is provided surrounding the first surface region within a preset range. The second surface region is recessed relative to other regions of the surface of the temple. The third surface region is encompassed within the second surface region.

In the present disclosure, the first touch sensor 14 is arranged adjacent to a first end of the temple 12, and the second touch sensor 15 is arranged adjacent to a second end of the temple 12. The first end is used for connection with the frame 11, and the second end serves as the tail end of the temple 12.

As shown in FIG. 4, in the present embodiment, the smart glasses may further include a speaker 16 and/or a light indication unit 17 which are connected to the controller 10. When a user operates the first touch sensor 14 or the second touch sensor 15, the controller 10 controls the speaker 16 to emit a prompt sound in a preset manner, or controls the light indication unit 17 to provide a light indication in a preset manner. The light indication unit 17 may be an LED lamp. The light indication unit 17 is encompassed within the field of view of the user after the smart glasses are worn, for example, an area adjacent to the joint of the frame 11 and the temple 12.

While controlling the smart glasses to be turned on or be turned off based on the touch operation signal, the controller 10 is further configured to control the speaker 16 to make a prompt sound and/or control the light indication unit 17 to emit an indication light.

The smart glasses may further include a 9-axis sensor 18 connected to the controller 10. The 9-axis sensor 18 is configured to collect motion data of the user and perform analysis (such as statistics of motion parameters and monitoring of motion posture), so as to better monitor and guide the user during exercise.

The smart glasses may further include a sound pickup device 19 connected to the controller 10, which may specifically be a microphone array including at least two microphones. The microphones may be deployed at different positions. For example, a first microphone, a second microphone, and a third microphone of the microphone array may all be installed on the same temple 12, and the first microphone and the second microphone are closer to the frame 11 than the third microphone. In each working mode, microphones at different positions may be controlled to pick up sound, thereby reducing noise in the acquired voice data and improving signal processing speed. For example, in a call mode, the first microphone and the second microphone are controlled to acquire voice data, while in a hearing-assistance mode, the first microphone, the second microphone, and the third microphone are controlled to acquire voice data.

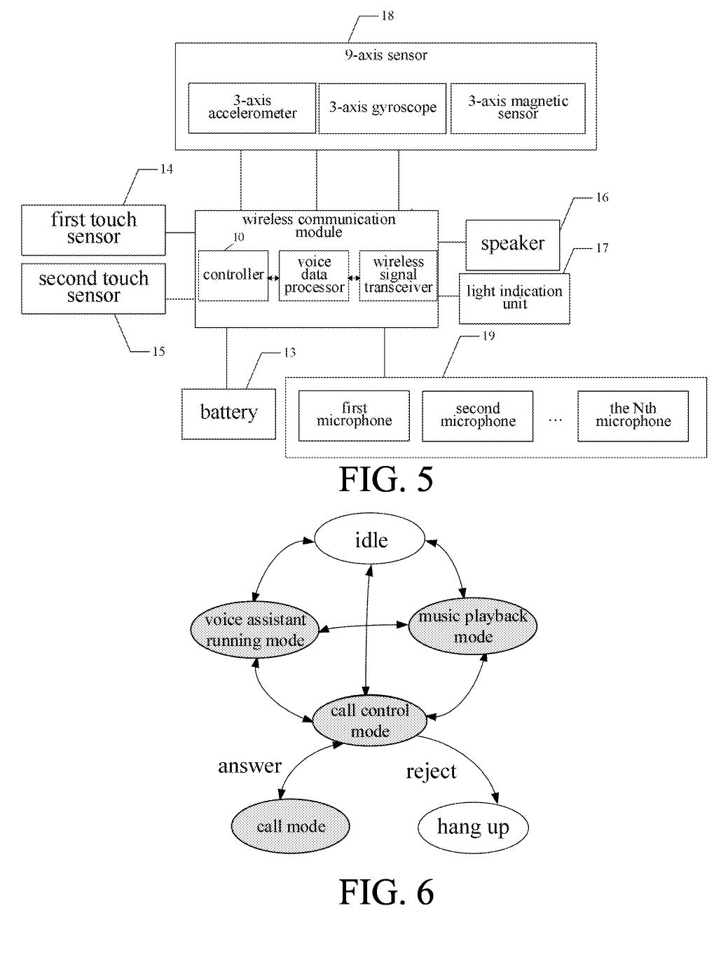

The controller 10 may be an independent controller, or may be integrated in a wireless communication module, as shown in FIG. 5. In the example shown in FIG. 5, the wireless communication module includes: the controller 10, a voice data processor, and a wireless signal transceiver. The controller 10, the voice data processor, and the wireless signal transceiver may be connected through a bus.

In some embodiments, the controller 10 is a microcontroller unit (MCU).

The voice data processor is configured to perform equalization processing on voice data, adjust sound data to be output into sound data having preset frequency bands and volumes, and send the adjusted sound data to the speaker for playback. In some embodiment, the voice data processor is a digital signal processor (DSP) or a voice data processing integrated circuit. The voice data processing integrated circuit may be a conventional circuit, and the present disclosure does not specifically limit its structure.

The wireless signal transceiver is configured to perform data interaction with a smart mobile terminal (such as a smartphone, smart watch, etc.). In some embodiments, the wireless communication module may use at least one of the following communication protocols to interact with the smart mobile terminal: Bluetooth^{®}, Wi-Fi, near field communication (NFC), ZigBee, digital living network alliance (DLNA), ultra-wideband (UWB), radio frequency identification (RFID), and cellular mobile communication protocols. Preferably, the Bluetooth^{®} protocol is used.

In the example shown in FIG. 5, the controller 10 directly reuses the microcontroller integrated in the wireless communication module, without the need to provide an additional controller. Moreover, since the wireless communication module performs relatively simple functions, the overall circuit structure of the smart glasses is simplified, the weight is reduced, and power consumption is also lowered.

Based on the smart glasses structure described above, in these embodiments of the present disclosure, it further provides a turn-on process, a turn-off process, and a working state switching process and control process for the smart glasses without the physical button. It should be noted that the following processes are only specific implementation examples and do not mean that the smart glasses without the physical button of the present disclosure can operate only according to the following processes. Various improvements and modifications may be made according to practical circumstances. The processes are described in detail as follows:

Turn-on Process-In a turn-off state, if the first touch sensor 14 detects a touch operation, it sends a touch operation signal to the controller 10. After receiving the touch operation signal, the controller 10 controls the speaker 16 to make a first prompt sound, such as a beep, and controls the light indication unit 17 to emit light of a first color, such as red light. At this time, the speaker 16 and the light indication unit 17 respectively provide audible and visual indications, so as to inform the user that a valid tapping operation has been performed on the first touch sensor 14.

If the controller 10 continuously receives the touch operation signal for a duration reaching a preset first duration threshold, such as 2 seconds, the controller 10 controls the smart glasses to be turned on, and controls the speaker 16 to emit a second prompt sound indicating the battery status, such as "battery high", "battery OK", or "battery low", while controlling the light indication unit 17 to emit light of a second color, such as blue light. Requiring the duration of the touch operation signal to reach the preset first duration threshold before starting up ensures that the user truly intends to be turned on the device, thereby avoiding immediate turn-on caused by accidental operations and preventing a poor user experience.

Further, if the controller 10 continuously receives the touch operation signal for a duration that does not reach the preset first duration threshold, the controller 10 controls the speaker 16 not to make any sound, controls the light indication unit 17 to be turned off, and controls the smart glasses to stay in the turn-off state.

Further, after starting up, when the speaker 16 makes the second prompt sound, if the duration during which the controller continuously receives the touch operation signal does not reach a preset second duration threshold, the smart glasses establish a connection with an intelligent terminal to enter a start-on connection state. After the connection is successfully established, the controller 10 controls the speaker 16 to make a third prompt sound indicating that the connection has been established, such as a voice prompt of "connected", and controls the light indication unit 17 to be turned off. After that, the smart glasses and the intelligent terminal may interact with each other.

Further, after starting up, when the speaker 16 makes the second prompt sound, if the controller 10 continuously receives the touch operation signal for a duration reaching a preset second duration threshold, the smart glasses enter a pairing state with the intelligent terminal. During the pairing process, the controller 10 controls the speaker 16 to emit a fourth prompt sound indicating that pairing is in progress, such as a voice prompt of "pairing", and controls the light indication unit 17 to alternately emit flashing lights of a third color and a fourth color, such as alternating red and blue flashing lights.

Turn-off Process-In a turn-off state, if the first touch sensor 14 detects a touch operation, it sends a touch operation signal to the controller 10. After receiving the touch operation signal, the controller 10 controls the speaker 16 to make a fifth prompt sound, such as a beep, and controls the light indication unit 17 to emit light of a fifth color, such as red light. At this time, the speaker 16 and the light indication unit 17 respectively provide audible and visual indications, so as to inform the user that a valid pressing operation has been performed on the first touch sensor 14.

After the speaker 16 emits the fifth prompt sound, if the controller 10 continuously receives the touch operation signal for a duration reaching a preset third duration threshold, such as 3 seconds, the controller 10 controls the speaker 16 to continuously emit a sixth prompt sound, such as a continuous beep, and controls the light indication unit 17 to continuously emit flashing light of a sixth color, such as continuous red flashing.

After the speaker 16 continuously emits the sixth prompt sound, if the controller 10 still receives the touch operation signal and the duration for which the touch operation signal continues to be received reaches a preset fourth duration threshold, such as an additional 2 seconds, the controller 10 controls the smart glasses to be turned off, and controls the speaker 16 to emit a seventh prompt sound indicating shutdown, such as a voice prompt of "shut down", while controlling the light indication unit 17 to be turned off. Requiring the duration of the touch operation signal to reach the preset fourth duration threshold before shutting down ensures that the user truly intends to be turned off the device, thereby preventing immediate shutdown caused by accidental operations and avoiding a poor user experience.

Further, after the speaker 16 makes the fifth prompt sound, if the controller 10 continuously receives the touch operation signal for a duration that does not reach the preset third duration threshold, the controller 10 controls the speaker 16 to stop emitting sound, controls the light indication unit 17 to be turned off, and controls the smart glasses to stay in the turn-on state.

Further, after the speaker 16 continuously makes the sixth prompt sound, if the controller 10 still receives the touch operation signal but the duration of the received touch operation signal does not reach the preset fourth duration threshold, the controller 10 controls the speaker 16 not to emit sound, controls the light indication unit 17 to be turned off, and controls the smart glasses to stay in the turn-on state.

Working State Switching Process-The smart glasses have a plurality of working modes, as shown in FIG. 6, including a music playback mode, a voice assistant running mode, a call control mode, call mode, and so on. The controller 10 is configured to control switching among the working modes of the smart glasses and, in each working mode, to control the working state of the smart glasses according to sliding operation signals detected by the second touch sensor 15. The voice assistant running mode may include voice amplification, translation, Siri assistant functionality, ChatGPT model services, and so on.

When the smart glasses are in the music playback mode, the voice assistant running mode, or the call mode: if the controller 10 detects a sliding operation in a first direction based on the sliding operation signal, it controls the speaker 16 to emit an eighth prompt sound and increases the music volume by one level; if the controller 10 detects a sliding operation in a second direction, it controls the speaker 16 to emit a ninth prompt sound and decreases the music volume by one level. When the volume reaches the maximum or minimum level, the controller 10 controls the speaker 16 to make a tenth prompt sound indicating the volume limit has been reached. The first direction and second direction are opposite, e.g., the first direction is sliding toward the second end of the temple 12, and the second direction is sliding toward the first end of the temple 12.

When the smart glasses are in the call mode and there is a new call: if the controller 10 detects that the touch operation on the first touch sensor 14 is shorter than a preset fifth duration threshold, it hangs up the current call and answers the new call; if the controller 10 detects that the touch operation on the first touch sensor 14 reaches the preset fifth duration threshold, it rejects the new call and continues the current call.

When the smart glasses are in the call control mode: if the controller 10 detects a sliding operation in the first direction, or a touch operation on the first touch sensor 14 reaching a preset sixth duration threshold, it answers the call; if the controller 10 detects a sliding operation in the second direction, it rejects the call.

Voice Assistant Running Mode Switching-If the smart glasses are in the turn-on state and the turn-off function is disabled, and the controller 10 continuously receives the touch operation signal for a preset seventh duration threshold, it controls the smart glasses to enter voice assistant running mode. The user interface of the intelligent terminal has a virtual button for disabling the turn-off function. When this button is active, the turn-off function of the smart glasses is disabled. In this embodiment, switching to the voice assistant running mode requires operating the first touch sensor 14 by the user. To differentiate this operation from shutting down, the intelligent terminal app disables the turn-off function, preventing conflicts between multiple processes.

The second embodiment of the present application provides an operating method for smart glasses without a physical button. The smart glasses include a frame; a first temple; a second temple; and a controller. The controller is embedded in the frame, the first temple or the second temple. A first touch sensor is built in the temple and connected to the controller. The structure of the first touch sensor is detailed in the first embodiment. The smart glasses may further include a speaker and a light indication unit which are connected to the controller.

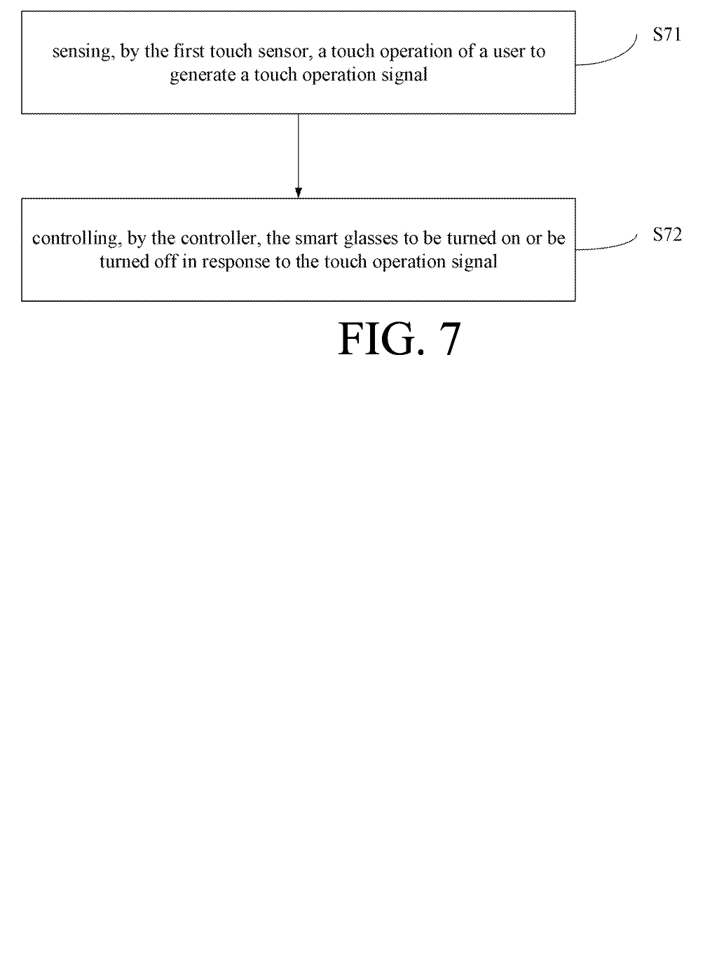

As shown in FIG. 7, the operating method includes:

S71: sensing, by the first touch sensor, a touch operation of a user to generate a touch operation signal; and

S72: controlling, by the controller, the smart glasses to be turned on or be turned off in response to the touch operation signal.

In one embodiment, the turn-on and turn-off processes may be combined with the speaker and light indication unit. The controller, in response to the touch operation signal, controls the smart glasses to be turned on or be turned off while controlling the speaker to emit prompt sounds and/or the light indication unit to emit indication light.

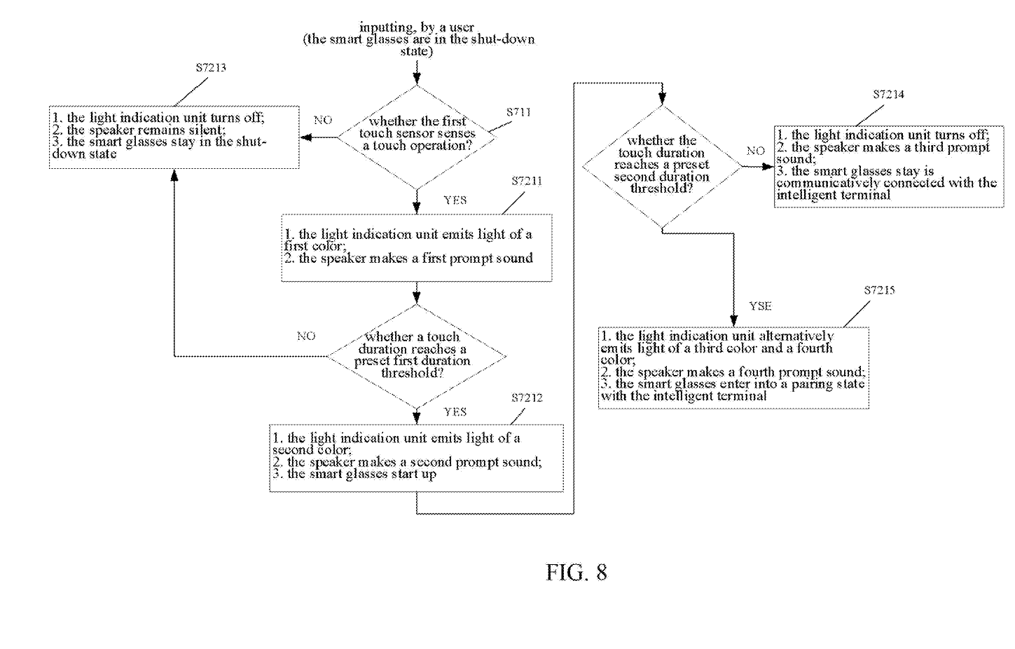

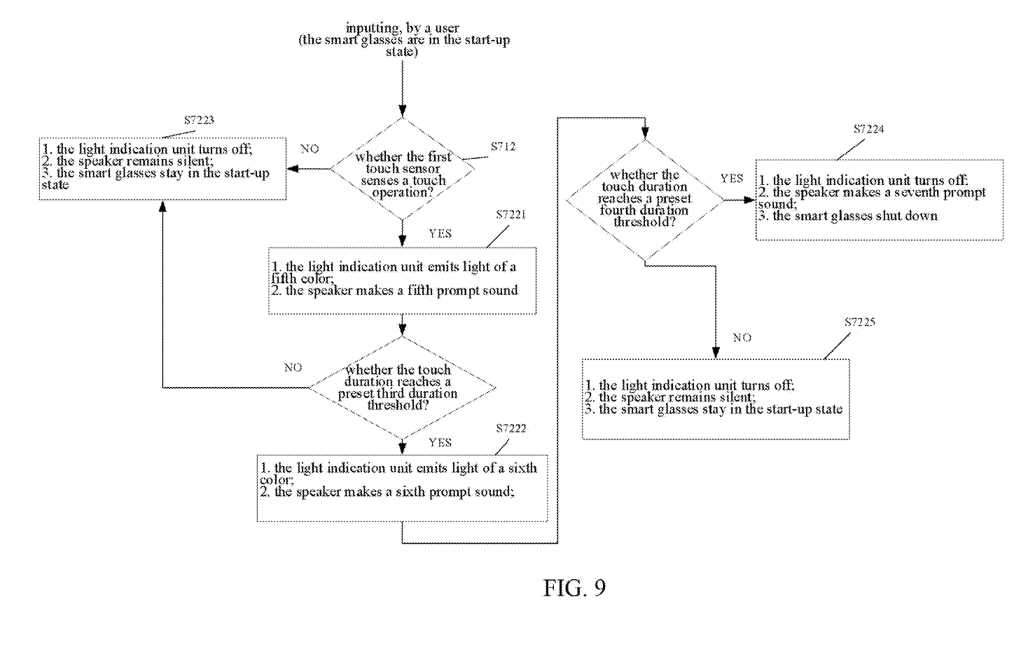

For starting up, in the step S71, the touch operation is detected in the turn-off state, corresponding to step S711 in FIG. 8. For shutting down, in the step S71, the touch operation is detected in the turn-on state, corresponding to step S712 in FIG. 9. The definitions of turn-on and turn-off are as described above.

As shown in FIG. 8, for starting up, the step S72 includes:

S7211: in response to the touch operation signal, controlling, by the controller, the speaker to make a first prompt sound, and controlling, by the controller, the light indication unit to emit light of a first color;

S7212: in case that a duration during which the controller continuously receives the touch operation signal reaches a preset first duration threshold and in response to the touch operation signal: controlling, by the controller, the smart glasses to be turned on; controlling, by the controller, the speaker to make a second prompt sound indicating a power level state, and controlling, by the controller, the light indication unit to emit light of a second color;

S7213: in case that the duration during which the controller continuously receives the touch operation signal does not reach the preset first duration threshold and in response to the touch operation signal: controlling, by the controller, the speaker to remain silent; controlling, by the controller, the light indication unit to be turned off, and controlling, by the controller, the smart glasses to stay in the turn-off state;

S7214: after the speaker makes the second prompt sound, in case that the duration during which the controller continuously receives the touch operation signal does not reach a preset second duration threshold and in response to the touch operation signal: controlling, by the controller, the smart glasses to establish a connection with an intelligent terminal to enter a start-on connection state; controlling, by the controller, the speaker to make a third prompt sound indicating connection; and controlling, by the controller, the light indication unit to be turned off after the connection is successfully established; and

S7215: after the speaker makes the second prompt sound, in case that the duration during which the controller continuously receives the touch operation signal reaches a preset second duration threshold and in response to the touch operation signal: controlling, by the controller, the smart glasses to enter a pairing state for connecting with the intelligent terminal; controlling, by the controller, the speaker to make a fourth prompt sound indicating being pairing during a pairing process; and controlling, by the controller, the light indication unit to alternately emit light of a third color and a fourth color.

As shown in FIG. 9, for shutting down, the step S72 includes:

S7221: in response to the touch operation signal: controlling, by the controller, the speaker to make a fifth prompt sound; and controlling, by the controller, the light indication unit to emit light of a fifth color;

S7222: after the speaker makes the fifth prompt sound, in case that the duration during which the controller continuously receives the touch operation signal reaches a preset third duration threshold and in response to the touch operation signal: controlling, by the controller, the speaker to make a sixth prompt sound continuously; and controlling, by the controller, the light indication unit to emit a flash of a sixth color continuously;

S7223: after the speaker makes the fifth prompt sound, in case that the duration during which the controller continuously receives the touch operation signal does not reach the preset third duration threshold and in response to the touch operation signal: controlling, by the controller, the speaker to remain silent; controlling, by the controller, the light indication unit to be turned off, and controlling, by the controller, the smart glasses to stay in the turn-on state;

S7224: after the speaker makes the sixth prompt sound continuously, in case that the controller still receives the touch operation signal and the duration during which the controller continuously receives the touch operation signal reaches a preset fourth duration threshold and in response to the touch operation signal: controlling, by the controller, the smart glasses to be turned off; controlling, by the controller, the speaker to make a seventh prompt sound indicating turn-off; and controlling, by the controller, the light indication unit to be turned off; and

S7225: after the speaker makes the sixth prompt sound continuously, in case that the controller still receives the touch operation signal but the duration during which the controller continuously receives the touch operation signal does not reach the preset fourth duration threshold and in response to the touch operation signal: controlling, by the controller, the speaker to remain silent; controlling, by the controller, the light indication unit to be turned off; and controlling, by the controller, the smart glasses to stay in the turn-on state.

Furthermore, a second touch sensor connected to the controller is built in the temple. Its shape and position relative to the first touch sensor are as described in the first embodiment. The operating method further includes:

sensing, by the second touch sensor, a sliding touch operation of the user to generate a sliding touch operation signal; and

controlling, by the controller, a working state of the smart glasses in response to the sliding touch operation signal.

Furthermore, the smart glasses have a plurality of working modes. The operating method further includes: controlling, by the controller, the working state of the smart glasses under each working mode in response to the sliding operation signal.

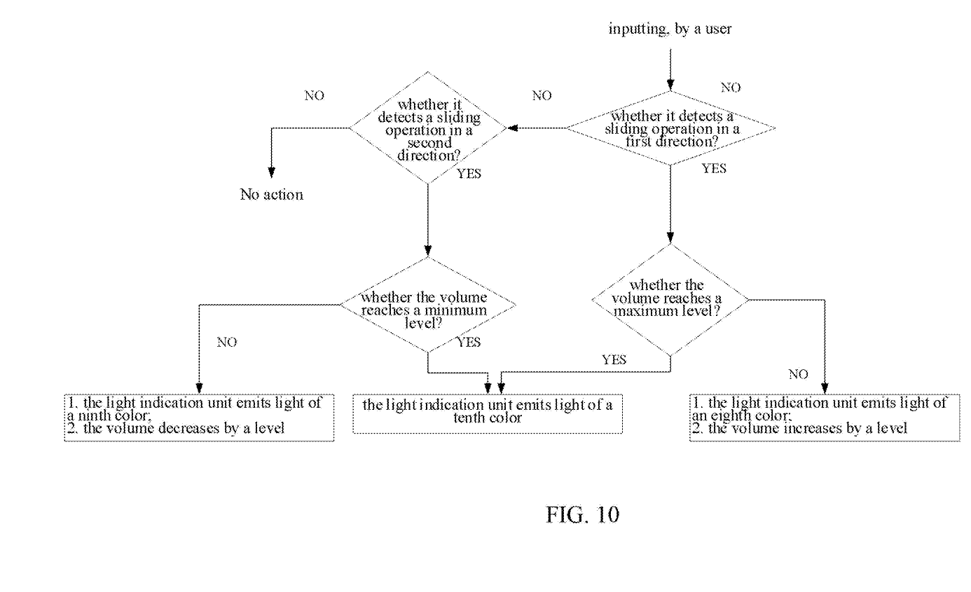

Furthermore, the plurality of working modes include a music playback mode, a voice assistant running mode, and a call mode. As shown in FIG. 10, the operating method further includes:

when the smart glasses are in the music playback mode, the voice assistant running mode, or the call mode: in case that the controller detects a sliding operation in a first direction and in response to the sliding operation signal: controlling, by the controller, the speaker to make an eighth prompt sound and to increase a music volume by one level;

in case that the controller detects a sliding operation in a second direction and in response to the sliding operation signal: controlling, by the controller, the speaker to make a ninth prompt sound and to decrease the music volume by one level; and

in case that the music volume reaches a maximum or minimum volume and in response to the sliding operation signal: controlling, by the controller, the speaker to make a tenth prompt sound indicating a volume limit.

The first direction is opposite to the second direction.

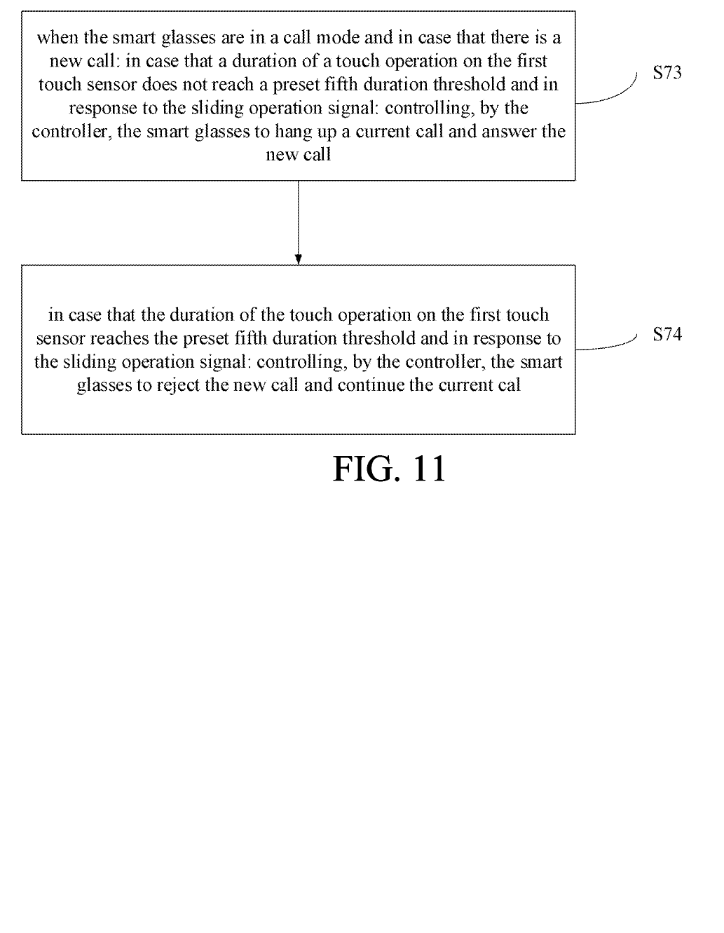

As shown in FIG. 11, the operating method further includes:

S73: when the smart glasses are in a call mode and in case that there is a new call: in case that a duration of a touch operation on the first touch sensor does not reach a preset fifth duration threshold and in response to the sliding operation signal: controlling, by the controller, the smart glasses to hang up a current call and answer the new call; and

S74: in case that the duration of the touch operation on the first touch sensor reaches the preset fifth duration threshold and in response to the sliding operation signal: controlling, by the controller, the smart glasses to reject the new call and continue the current call.

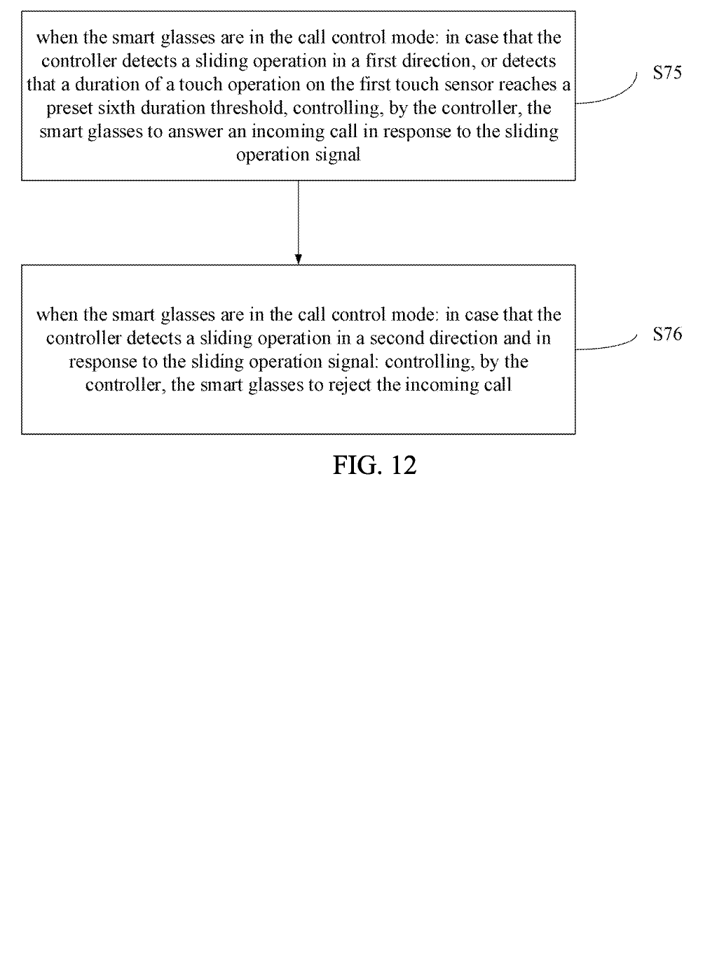

The plurality of working modes include a call control mode. As shown in FIG. 12, the operating method further includes:

S75: when the smart glasses are in the call control mode: in case that the controller detects a sliding operation in a first direction, or detects that a duration of a touch operation on the first touch sensor reaches a preset sixth duration threshold, controlling, by the controller, the smart glasses to answer an incoming call in response to the sliding operation signal; and

S76: when the smart glasses are in the call control mode: in case that the controller detects a sliding operation in a second direction and in response to the sliding operation signal: controlling, by the controller, the smart glasses to reject the incoming call.

The operating method further includes:

when the smart glasses are in a turn-on state and a turn-off function is disabled: in case that a duration during which the controller continuously receives the touch operation signal reaches a preset seventh duration threshold and in response to the sliding operation signal: controlling, by the controller, the smart glasses to enter the voice assistant running mode;

A user interface on the intelligent terminal has a virtual button for disabling the turn-off function, and the turn-off function is disabled when the virtual button for disabling the turn-off function is activated.

In the various embodiments provided in the present disclosure, it should be understood that the disclosed smart glasses without physical buttons and their operating methods can be implemented in other ways. For example, multiple modules or components may be combined or integrated into another system, or certain features may be omitted or not executed. Furthermore, the illustrated or discussed coupling, direct coupling, or communication connections between components may also be implemented through indirect coupling or communication via interfaces, devices, or modules, and can be electrical, mechanical, or in other forms.

It should be noted that, for the aforementioned method embodiments, for simplicity of description, they are expressed as a series of actions. However, those skilled in the art should understand that this disclosure is not limited by the described order of actions, since certain steps may be performed in other sequences or simultaneously according to the present disclosure. Moreover, those skilled in the art should recognize that the embodiments described in the specification are preferred embodiments, and the actions and modules involved are not necessarily all required by this disclosure.

In the above embodiments, the descriptions of each embodiment have different focuses. Parts that are not elaborated in one embodiment may refer to relevant descriptions in other embodiments.

The above constitutes a description of the smart glasses, control methods, and systems provided in this disclosure. For those skilled in the art, based on the concepts of the embodiments of this disclosure, there may be changes in specific implementation and disclosure scope. In summary, the content of this specification should not be understood as limiting the scope of this disclosure.

What is claimed is:

1. Smart glasses without a physical button, characterized by comprising: a frame; a first temple; a second temple; and a controller embedded in the frame, the first temple or the second temple, wherein the first and second temples are connected to the frame;
wherein a first touch sensor is built in the first temple and connected to the controller, and the first touch sensor is configured to send a sensed touch operation signal to the controller; and
wherein the controller is configured to control the smart glasses to be turned on or turned off based on the touch operation signal.

2. The smart glasses without the physical button according to claim 1, characterized in that a surface of the first temple comprises a first surface region corresponding to the first touch sensor and a remaining region, and the first surface region is non-coplanar with the remaining region.

3. The smart glasses without the physical button according to claim 2, characterized in that the first surface region protrudes from the remaining region.

4. The smart glasses without the physical button according to claim 3, characterized in that the remaining region comprises a second surface region surrounding the first surface region within a preset range and an other surface region, and the second surface region is recessed relative to the other surface region.

5. The smart glasses without the physical button according to claim 2, characterized in that the first surface region is recessed relative to the remaining region.

6. The smart glasses without the physical button according to claim 5, characterized in that the remaining region comprises a second surface region surrounding the first surface region within a preset range and an other surface region, and the second surface region protrudes from the other surface region.

7. The smart glasses without the physical button according to claim 1, characterized by further comprising: a speaker and a light indication unit which are connected to the controller;
wherein the controller is further configured to, control the speaker to make a prompt sound, and/or control the light indication unit to emit indicator light while controlling the smart glasses to be turned on or turned off based on the touch operation signal.

8. The smart glasses without the physical button according to claim 7, characterized in that when the smart glasses are in a turn-off state and the first touch sensor senses a touch operation and sends the touch operation signal to the controller, the controller, after receiving the touch operation signal, is configured to:
control the speaker to make a first prompt sound, and control the light indication unit to emit light of a first color; and
control the smart glasses to be turned on, control the speaker to make a second prompt sound indicating a power level state, and control the light indication unit to emit light of a second color in case that a duration during which the controller continuously receives the touch operation signal reaches a preset first duration threshold.

9. The smart glasses without the physical button according to claim 8, characterized in that in case that the duration during which the controller continuously receives the touch operation signal does not reach the preset first duration threshold, the controller is configured to: control the speaker to remain silent, control the light indication unit to be turned off, and control the smart glasses to stay in the turn-off state.

10. The smart glasses without the physical button according to claim 8, characterized in that after the speaker makes the second prompt sound, the controller is configured to, in case that the duration during which the controller continuously receives the touch operation signal does not reach a preset second duration threshold: control the smart glasses to establish a connection with an intelligent terminal to enter a start-on connection state, control the speaker to make a third prompt sound indicating connection and control the light indication unit to be turned off after the connection is successfully established.

11. The smart glasses without the physical button according to claim 8, characterized in that after the speaker makes the second prompt sound, the controller is configured to, in case that the duration during which the controller continuously receives the touch operation signal reaches a preset second duration threshold: control the smart glasses to enter a pairing state for connecting with the intelligent terminal, control the speaker to make a fourth prompt sound indicating being pairing during a pairing process, and control the light indication unit to emit light of a third color and a fourth color alternately.

12. The smart glasses without the physical button according to claim 7, characterized in that when the smart glasses are in a turn-on state and the first touch sensor senses a touch operation and sends the touch operation signal to the controller, the controller, after receiving the touch operation signal, is configured to:
control the speaker to make a fifth prompt sound and control the light indication unit to emit light of a fifth color;
after the speaker makes the fifth prompt sound, control the speaker to make a sixth prompt sound continuously and control the light indication unit to emit a flash of a sixth color continuously in case that the duration during which the controller continuously receives the touch operation signal reaches a preset third duration threshold; and
after the speaker makes the sixth prompt sound continuously, control the smart glasses to be turned off, control the speaker to make a seventh prompt sound indicating being turning off, and control the light indication unit to be turned off in case that the controller still receives the touch operation signal and the duration during which the controller continuously receives the touch operation signal reaches a preset fourth duration threshold.

13. The smart glasses without the physical button according to claim 12, characterized in that after the speaker makes the sixth prompt sound continuously, in case that the controller still receives the touch operation signal but the duration during which the controller continuously receives the touch operation signal does not reach the preset fourth duration threshold, the controller is configured to: control the speaker to remain silent, control the light indication unit to be turned off, and control the smart glasses to stay in the turn-on state.

14. The smart glasses without the physical button according to claim 12, characterized in that after the speaker makes the fifth prompt sound, in case that the duration during which the controller continuously receives the touch operation signal does not reach the preset third duration threshold, the controller is configured to: control the speaker to remain silent, control the light indication unit to be turned off, and control the smart glasses to stay in the turn-on state.

15. The smart glasses without the physical button according to claim 1, characterized in that a second touch sensor is built in the first temple and connected to the controller, and the second touch sensor is configured to send a sensed sliding operation signal to the controller;
wherein the controller is configured to control a working state of the smart glasses based on the sliding operation signal.

16. The smart glasses without the physical button according to claim 15, characterized in that a surface of the first temple comprises a first surface region corresponding to the first touch sensor and a third surface region corresponding to the second touch sensor, a first isolation region is provided between the third surface region and the first surface region, and the first isolation region has no touch detection function.

17. The smart glasses without the physical button according to claim 15, characterized in that the second touch sensor comprises a plurality of touch sensor units, a second isolation region is arranged between every two adjacent touch sensor units of the plurality of touch sensor units, and the second isolation region has no touch detection function.

18. The smart glasses without the physical button according to claim 17, characterized in that the second isolation region is zigzag-shaped.

19. The smart glasses without the physical button according to claim 15, characterized in that a surface of the first temple comprises a first surface region corresponding to the first touch sensor, a second surface region surrounding the first surface region within a preset range and an other surface region, the second surface region comprises a third surface region corresponding to the second touch sensor, the second surface region is recessed relative to the other surface region, and the third surface region is encompassed within the second surface region.

20. The smart glasses without the physical button according to claim 15, characterized in that the first touch sensor is located adjacent to a first end of the first temple, the second touch sensor is located adjacent to a second end of the first temple, the first end is connected with the frame, and the second end is a tail end of the first temple.

21. The smart glasses without the physical button according to claim 15, characterized in that the smart glasses have a plurality of working modes and further comprise a speaker and a light indication unit which are connected to the controller;
wherein the controller is configured to: control the smart glasses to switch among the plurality of working modes, and control the working state of the smart glasses according to the sensed sliding operation signal by the second touch sensor under each working mode.

22. The smart glasses without the physical button according to claim 21, characterized in that the plurality of working modes comprise a music playback mode, a voice assistant running mode, and a call mode;
wherein when the smart glasses are in the music playback mode, the voice assistant running mode, or the call mode, the controller is configured to:
control the speaker to make an eighth prompt sound and to increase a music volume by one level, in case that the controller detects a sliding operation in a first direction;
control the speaker to make a ninth prompt sound and to decrease the music volume by one level, in case that the controller detects a sliding operation in a second direction; and
control the speaker to make a tenth prompt sound indicating a volume limit, in case that the music volume reaches a maximum or minimum volume, and
wherein the first direction is opposite to the second direction.

23. The smart glasses without the physical button according to claim 21, characterized in that when the smart glasses are in a call mode and in case that there is a new call, the controller is configured to:
control the smart glasses to hang up a current call and answer the new call, in case that a duration of a touch operation on the first touch sensor does not reach a preset fifth duration threshold; and
control the smart glasses to reject the new call and continue the current call, in case that the duration of the touch operation on the first touch sensor reaches the preset fifth duration threshold.

24. The smart glasses without the physical button according to claim 21, characterized in that the plurality of working modes comprise a call control mode;
wherein when the smart glasses are in the call control mode, the controller is configured to:
control the smart glasses to answer an incoming call, in case that the controller detects a sliding operation in a first direction, or detects that a duration of a touch operation on the first touch sensor reaches a preset sixth duration threshold; and
control the smart glasses to reject the incoming call, in case that the controller detects a sliding operation in a second direction.

25. The smart glasses without the physical button according to claim 22, characterized in that when the smart glasses are in a turn-on state and a turn-off function is disabled, the controller is configured to:
control the smart glasses to enter the voice assistant running mode, in case that a duration during which the controller continuously receives the touch operation signal reaches a preset seventh duration threshold;
wherein a user interface on the intelligent terminal has a virtual button for disabling the turn-off function, and the turn-off function is disabled when the virtual button for disabling the turn-off function is activated.

26. An operating method of smart glasses without a physical button, characterized in that the smart glasses comprise: a frame; a first temple; a second temple; and a controller embedded in the frame, the first temple or the second temple, the first and second temples are connected to the frame, and a first touch sensor is built in the first temple and connected to the controller; wherein the operating method comprises:
sensing, by the first touch sensor, a touch operation of a user to generate a touch operation signal; and
controlling, by the controller, the smart glasses to be turned on or be turned off in response to the touch operation signal.

27. The operating method according to claim 26, characterized in that the smart glasses further comprise a speaker and a light indication unit which are connected to the controller;
wherein the step of controlling, by the controller, the smart glasses to be turned on or be turned off in response to the touch operation signal, comprises:
controlling, by the controller and in response to the touch operation signal, the speaker to make a prompt sound and/or the light indication unit to emit indicator light while controlling the smart glasses to be turned on or be turned off.

28. The operating method according to claim 27, characterized in that the step of sensing, by the first touch sensor, a touch operation of a user to generate a touch operation signal, comprises:
sensing, by the first touch sensor, the touch operation of the user to generate the touch operation signal, when the smart glasses are in a turn-off state;
wherein the step of controlling, by the controller and in response to the touch operation signal, the speaker to make a prompt sound and/or the light indication unit to emit indicator light while controlling the smart glasses to be turned on or be turned off, comprises:
in response to the touch operation signal, controlling, by the controller, the speaker to make a first prompt sound, and controlling, by the controller, the light indication unit to emit light of a first color;
in case that a duration during which the controller continuously receives the touch operation signal reaches a preset first duration threshold and in response to the touch operation signal: controlling, by the controller, the smart glasses to be turned on; controlling, by the controller, the speaker to make a second prompt sound indicating a power level state, and controlling, by the controller, the light indication unit to emit light of a second color;
in case that the duration during which the controller continuously receives the touch operation signal does not reach the preset first duration threshold and in response to the touch operation signal: controlling, by the controller, the speaker to remain silent; controlling, by the controller, the light indication unit to be turned off, and controlling, by the controller, the smart glasses to stay in the turn-off state;
after the speaker makes the second prompt sound, in case that the duration during which the controller continuously receives the touch operation signal does not reach a preset second duration threshold and in response to the touch operation signal: controlling, by the controller, the smart glasses to establish a connection with an intelligent terminal to enter a start-on connection state; controlling, by the controller, the speaker to make a third prompt sound indicating connection; and controlling, by the controller, the light indication unit to be turned off after the connection is successfully established; and
after the speaker makes the second prompt sound, in case that the duration during which the controller continuously receives the touch operation signal reaches a preset second duration threshold and in response to the touch operation signal: controlling, by the controller, the smart glasses to enter a pairing state for connecting with the intelligent terminal; controlling, by the controller, the speaker to make a fourth prompt sound indicating being pairing during a pairing process; and controlling, by the controller, the light indication unit to emit light of a third color and a fourth color alternately.

29. The operating method according to claim 27, characterized in that the step of sensing, by the first touch sensor, a touch operation of a user to generate a touch operation signal, comprises:
sensing, by the first touch sensor, the touch operation of the user to generate the touch operation signal, when the smart glasses are in a turn-on state;
wherein the step of controlling, by the controller and in response to the touch operation signal, the speaker to make a prompt sound and/or the light indication unit to emit indicator light while controlling the smart glasses to be turned on or be turned off, comprises:
in response to the touch operation signal: controlling, by the controller, the speaker to make a fifth prompt sound; and controlling, by the controller, the light indication unit to emit light of a fifth color;
after the speaker makes the fifth prompt sound, in case that the duration during which the controller continuously receives the touch operation signal reaches a preset third duration threshold and in response to the touch operation signal: controlling, by the controller, the speaker to make a sixth prompt sound continuously; and controlling, by the controller, the light indication unit to emit a flash of a sixth color continuously;
after the speaker makes the fifth prompt sound, in case that the duration during which the controller continuously receives the touch operation signal does not reach the preset third duration threshold and in response to the touch operation signal: controlling, by the controller, the speaker to remain silent; controlling, by the controller, the light indication unit to be turned off, and controlling, by the controller, the smart glasses to stay in the turn-on state;
after the speaker makes the sixth prompt sound continuously, in case that the controller still receives the touch operation signal and the duration during which the controller continuously receives the touch operation signal reaches a preset fourth duration threshold and in response to the touch operation signal: controlling, by the controller, the smart glasses to be turned off; controlling, by the controller, the speaker to make a seventh prompt sound indicating turn-off; and controlling, by the controller, the light indication unit to be turned off; and
after the speaker makes the sixth prompt sound continuously, in case that the controller still receives the touch operation signal but the duration during which the controller continuously receives the touch operation signal does not reach the preset fourth duration threshold and in response to the touch operation signal: controlling, by the controller, the speaker to remain silent; controlling, by the controller, the light indication unit to be turned off; and controlling, by the controller, the smart glasses to stay in the turn-on state.

30. The operating method according to claim 26, characterized in that a second touch sensor is built in the first temple and connected to the controller;
wherein the operating method further comprises:
sensing, by the second touch sensor, a sliding touch operation of the user to generate a sliding touch operation signal; and
controlling, by the controller, a working state of the smart glasses in response to the sliding touch operation signal.

31. The operating method according to claim 30, characterized in that the smart glasses have a plurality of working modes, and further comprise a speaker and a light indication unit which are connected to the controller;
wherein the operating method further comprises:
controlling, by the controller, the working state of the smart glasses under each working mode in response to the sliding operation signal.

32. The operating method according to claim 31, characterized in that the plurality of working modes comprise a music playback mode, a voice assistant running mode, and a call mode;
wherein the operating method further comprises:
when the smart glasses are in the music playback mode, the voice assistant running mode, or the call mode:
in case that the controller detects a sliding operation in a first direction and in response to the sliding operation signal: controlling, by the controller, the speaker to make an eighth prompt sound and to increase a music volume by one level;
in case that the controller detects a sliding operation in a second direction and in response to the sliding operation signal: controlling, by the controller, the speaker to make a ninth prompt sound and to decrease the music volume by one level; and
in case that the music volume reaches a maximum or minimum volume and in response to the sliding operation signal: controlling, by the controller, the speaker to make a tenth prompt sound indicating a volume limit; and
wherein the first direction is opposite to the second direction.

33. The operating method according to claim 31, characterized by further comprising:
when the smart glasses are in a call mode and in case that there is a new call:
in case that a duration of a touch operation on the first touch sensor does not reach a preset fifth duration threshold and in response to the sliding operation signal: controlling, by the controller, the smart glasses to hang up a current call and answer the new call; and
in case that the duration of the touch operation on the first touch sensor reaches the preset fifth duration threshold and in response to the sliding operation signal: controlling, by the controller, the smart glasses to reject the new call and continue the current call.

34. The operating method according to claim 31, characterized in that the plurality of working modes comprise a call control mode;
wherein the operating method further comprises:
when the smart glasses are in the call control mode:
in case that the controller detects a sliding operation in a first direction, or detects that a duration of a touch operation on the first touch sensor reaches a preset sixth duration threshold, controlling, by the controller, the smart glasses to answer an incoming call in response to the sliding operation signal; and
in case that the controller detects a sliding operation in a second direction and in response to the sliding operation signal: controlling, by the controller, the smart glasses to reject the incoming call.

35. The operating method according to claim 32, characterized by further comprising:
when the smart glasses are in a turn-on state and a turn-off function is disabled:
in case that a duration during which the controller continuously receives the touch operation signal reaches a preset seventh duration threshold and in response to the sliding operation signal: controlling, by the controller, the smart glasses to enter the voice assistant running mode;
wherein a user interface on the intelligent terminal has a virtual button for disabling the turn-off function, and the turn-off function is disabled when the virtual button for disabling the turn-off function is activated.
